(19) United States
(12) Patent Application Publication
(10) Pub. No.: US 2026/0300374 A1
(43) Pub. Date: Oct. 1, 2026

(54) APP SEARCH BASED ON VERBAL DESCRIPTION OF ICON

(71) Applicant: Lenovo (United States) Inc., Morrisville, NC (US)

(72) Inventors: Alanderson Salomão Gonçalves, Morrisville, NC (US); Gelson José de Almeida Filho, Morrisville, NC (US); Otavio Marelli Marques, Morrisville, NC (US)

(21) Appl. No.: 19/096,341

(22) Filed: Mar. 31, 2025

(51) Int. Cl. G06F 16/432; G06F 16/438; G06F 40/20; G06N 3/0464

(52) U.S. Cl. CPC G06F 16/433; G06F 16/438; G06F 40/20; G06N 3/0464

(57) ABSTRACT

A computer implemented method includes receiving a search request from a user device, the search request including a verbal description of attributes of an icon corresponding to an app. The search request is processed via a natural language processing model to derive an intent of the search request to search for icon attributes. An icon knowledge base is searched in response to the derived intent. The icon knowledge base includes records with icon attributes generated by a convolutional neural network image processor based on icons collected from an app storage, to identify a ranked list of apps. A search results is provided to the user device and identifies at least a top ranked app having an icon matching the verbal description of attributes.

### BACKGROUND

Users have difficulty managing their installed apps on smartphones. Additionally, there are poor methods for finding apps in the user's library or in stores is typically limited to searching for functions performed by apps or by typing a name of a desired app. Search engines may also be used to find apps in stores in a similar manner.

### SUMMARY

A computer implemented method includes receiving a search request from a user device, the search request including a verbal description of attributes of an icon corresponding to an app. The search request is processed via a natural language processing model to derive an intent of the search request to search for icon attributes. An icon knowledge base is searched in response to the derived intent. The icon knowledge base includes records with icon attributes generated by a convolutional neural network image processor based on icons collected from an app storage, to identify a ranked list of apps. A search results is provided to the user device and identifies at least a top ranked app having an icon matching the verbal description of attributes.

### BRIEF DESCRIPTION OF THE DRAWINGS

FIG. 1 is a block flow diagram of a system for collecting and storing data related apps and in particular for modifying the data to form verbal descriptions of icons corresponding to the apps according to an example embodiment.

FIG. 2 is a block flow diagram illustrating components used in searching for apps based on a user provided verbal description of an icon according to an example embodiment.

FIG. 3 is a block diagram of a record for an app in a knowledge base according to an example embodiment. FIG. 4 is a flowchart illustrating a method of searching for apps based on verbal descriptions of icons associated with the apps according to an example embodiment.

FIG. 5 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized, and that structural, logical and electrical changes may be made without departing from the scope of the present invention. The following description of example embodiments is, therefore, not to be taken in a limited sense, and the scope of the present invention is defined by the appended claims.

An application management artificial intelligence system assists users in finding apps on their smart phone or in an app store. The system searches for apps based on a user provided verbal description of an icon associated with a desired app.

To perform the search, the system may populate an app knowledge base with app icons by searching for apps on at least one of the smartphone and/or cloud-based app sources. Apps along with associated icons and descriptions of the apps are processed via the system to generate a knowledge base. The icons may be processed by a convolutional neural network image processor to generate a list of verbal characteristics or attributes of the icons. Such a list is stored in the knowledge base along with an image of the icon and description of the app or at least a link to the app to obtain the icon and description. The search then finds most likely icons by comparing the stored verbal characteristics to the verbal description provided by a user comprising a search request.

In one example, an icon-based search for apps can be performed based on verbal user input describing attributes of characteristics of an icon associated with an app. For example, the user may recall an icon for an app related to golf. The user may input characteristics of the icon in words, such as golf ball, golf club, golf, golf flag, or other characteristics. The system will return a list of one or more apps that have associated icons having golf themes or images related to golf.

A users smartphone may contain several icons related to golf that are found by the search. The icons most closely related to the search request may be provided as a search results list in order of confidence.

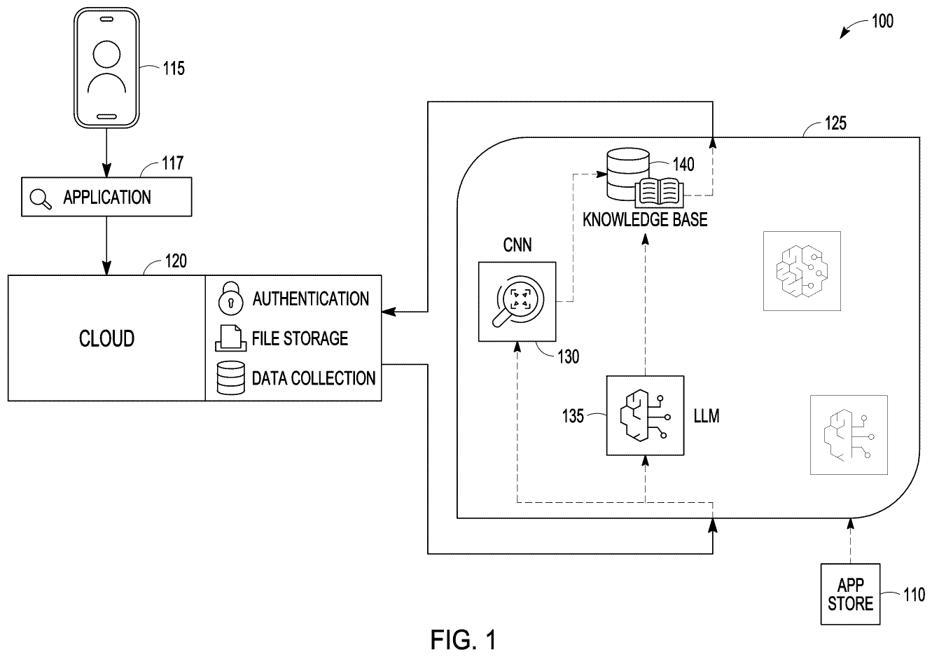

FIG. 1 is a block flow diagram of a system 100 for collecting and storing data related apps and in particular for modifying the data to form verbal descriptions of icons corresponding to the apps. System 100 collects app data from at least one or both of an app store 110 offering apps for downloading or from a device 115, such as a smartphone, having installed apps and an app management application 117.

In one example, device 115 may be coupled via the app management application 117 to cloud-based resources 120 that can obtain app information regarding installed apps on the device 115, authenticate the device and/or apps and provide the app information to a data processing block 125. The data modification block may include one or more artificial intelligence (AI) models, such as image processing model 130 and large language model (LLM) 135. In further examples, device 115 may include suitable resources for performing functions of the could-based resources 120 and data processing block 125.

Image processing model 130 receives icons of the apps obtained from the device 115 or app store 110 and extracts verbal descriptions, such as attributes, of the icons. An example image processing model 130 includes Amazon's Rekognition Image model which detect objects, scenes, and concepts in images. Model 130 can also recognize celebrities, detect text in a variety of languages, and detect, analyze, and compare faces and facial attributes like age and emotions.

The extracted verbal descriptions of the icons are stored in an app knowledge base 140 along with other information about the corresponding app, such as a location of the app and a name and description of the functions of the app. The location of the app may identify that the app is installed on the device 115 or is available from the app store 110.

LLM 135, such as Claude, Llama, or GPT, may process text contained in the app information to provide descriptions of the app for populating in the app knowledge base 140. In some examples, the LLM need not be used, and the retrieved app information may be appended directly in the knowledge base 140.

The knowledge base 140 may be accessible to the device 114 via the cloud-based resources 120, which may also provide authentication, file storage, and data collection services.

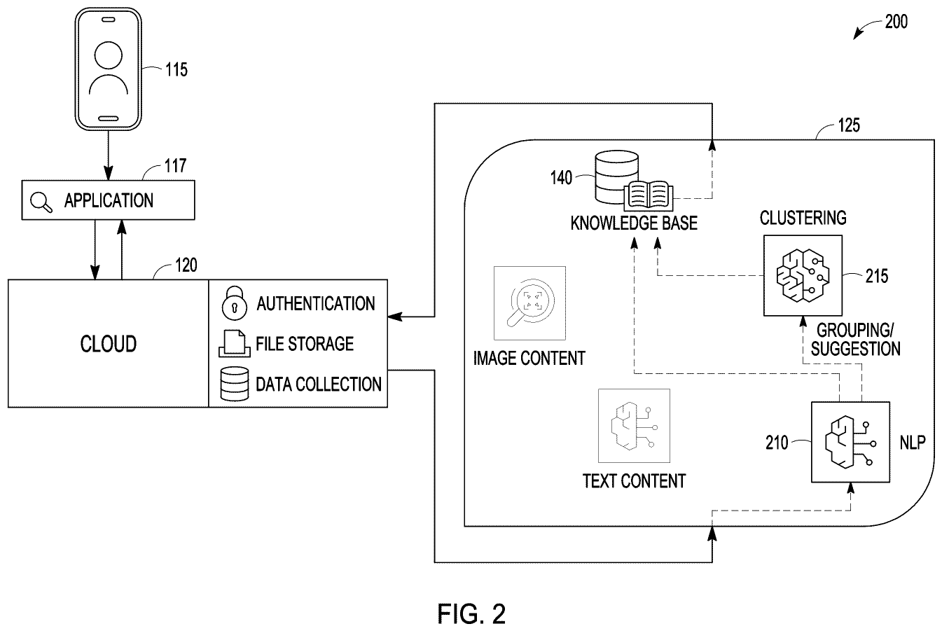

FIG. 2 is a block flow diagram 200 illustrating components used in searching for apps based on a user provided verbal description of the icon. Components in FIG. 2 that are consistent with components in FIG. 1 are provided with same reference numbers.

Users of device 115 may use the application to generate a search request intended for searching knowledge base 140. The search request, as referenced above, includes a verbal description of characteristics or attributes of an icon corresponding to an app. The search request is forwarded through the cloud-based resources 120 to the data processing block 125 which may include a natural language processing model or NLP service 210. The knowledge base 140 contains a search engine configured to search the knowledge base records for descriptions of icons that match or closely match the verbal description of the search request. The term match is used to designate that a found record contains a one or more terms that identically match or likely match verbal description in the search request. Matching results may be ranked based on closeness or confidence scores. Results of the search are forwarded through the cloud-based resources 120 back to the application 117 for viewing on user device 115.

In one example, NLP service 210 may utilize Amazon Comprehend, a natural language processing (NLP) service to process the search request and classify records in the knowledge base that have confidence scores above a desired threshold. The results may be ranked by confidence score and provided back to application 117 for generating a display of the results via device 115.

Data processing block 125 may also include a clustering function 215 that selects apps from knowledge base 140 based on the search request and apps that are found by the NLP service 210 having icon attributes closely matching the words in the search request. Clustering function 215 may utilize K-means clustering. In one example, clustering function 215 may utilize a recommendation app such as Factorization machines+XGBoost.

In one example of a user trying to search for an app based on characteristics or attributes of an associated icon include the user typing on search bar of application 117: “owl icon” or “owl” or “find the app with an owl logo”. The application 117 sends the request to the cloud-based resources 120 which forwards the request to the data processing block 125. The NLP service 210 processes the request to derive an intent of the text in the request: “owl”. The intent identifies that the user is searching for an icon image that includes an owl attribute.

In one example, the derived intent is used to forward the request to the knowledge base 140 where the icons attributes are stored and assigned to a corresponding app. The knowledge base 140, in response to the derived intent identifying that icon attributes are to be searched, queries the records for attributes that match “owl”. Results are provided back to the application 117 which causes display of all apps with owl on its icon, such as the Duolingo app or Tripadvisor app, which each contain an owl in its icon.

In one example, the data processing block 125 is fed with information from an app library on the device 115. The information may include descriptions, images of icons, and other information associated with apps installed on the device 115. The information is provided to the cloud-based resources 120 or other suitable processing resources, and then to the data processing block 125 where the LLM 135 and CNN image processing model 130 process the information and assign derived icon attributes and text information to the corresponding apps. The assigned attributes and text information are used to populate the knowledge base 140.

An icon associated with an app can have more than one attribute, and all attributes should be stored and assigned to the app. For example, the Duolingo app icon has the color green, has eyes, a beak, and has a rectangle or square with rounded corners. The Tripadvisor app icon has similar additional attributes of green, eyes, and a rectangle or square with rounded corners. With each of these attributes stored in the knowledge base 140, searching text describing such attributes will also return both apps.

As additional apps are installed or uninstalled on the device 115, the knowledge base 140 may be updated to only include records for apps installed on the device 115. Such updates can be performed periodically with a certain frequency of time, or in response to a user installing a new app or uninstalling an app.

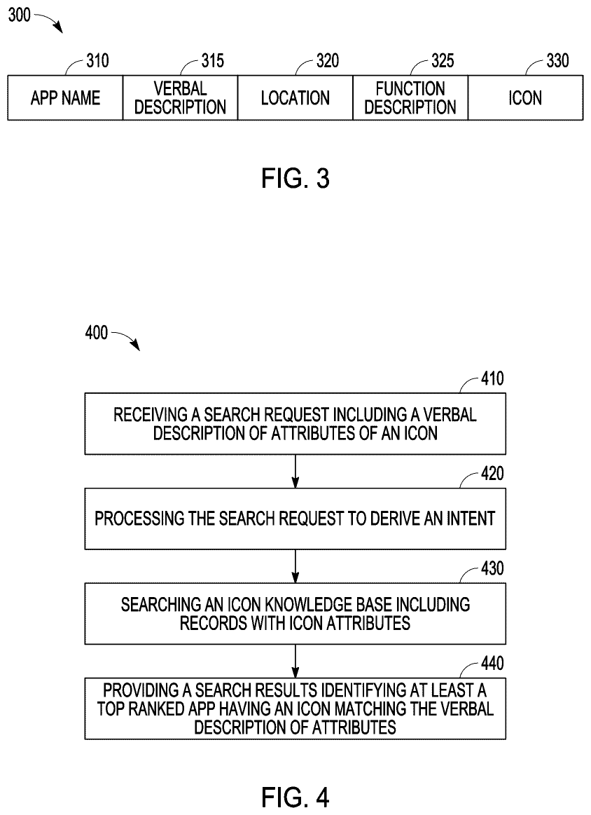

FIG. 3 is a block diagram of a record 300 for an app in knowledge base 140. Record 300 may be a JSON record or other type of record that includes a name of the app 310, extracted verbal descriptions of an associated icon 315, a location of the app 320, a description of the functions of the app 325 and a link to or thumbnail image of the app's icon 330. Record 300 may also include further information. The location of the app 320 may identify that the app is installed on the device 115 or is available from the app store 110.

The LLM 135 will get more information from the app and use this to associate it to the icon and improve the knowledge base. Such information may include app descriptions and images, including icons and other images associated with the app.

FIG. 4 is a flowchart illustrating a method 400 of searching for apps based on verbal descriptions of icons associated with the apps. Method 400 begins at operation 410 by receiving a search request from a user device. The search request may be received from an app management application executing on the user device. The search request includes a verbal description of attributes of an icon corresponding to an app. The search request is processed at operation 420 via a natural language processing model to derive an intent of the search request to search for icon attributes.

Operation 430 searches an icon knowledge base in response to the derived intent. The icon knowledge base includes records with icon attributes generated by an image processor based on icons collected from an app storage, to identify a ranked list of apps. The search is performed to identify records of the icon knowledge base based on the verbal description of the search request. In one example, the image processor comprises a convolutional neural network image processor.

A search result is provided to the user device at operation 440. The search result identifies at least a top ranked app having an icon matching the verbal description of attributes. If the app is not installed on the smartphone, the search result includes a link to install the installed app.

The icon knowledge base comprises records, each record containing an app name in addition to the icon attributes. The record may identify that the app is installed on the user device or available from an app store. The record may also include a description of a function of the app, a thumbnail of the icon, and a link to an image of the icon.

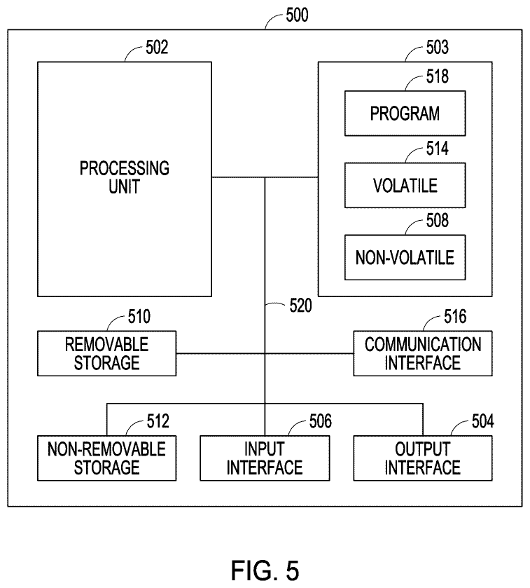

FIG. 5 is a block schematic diagram of a computer system 500 to implement one or more of the smartphone, cloud-based resources, data processing block, models, and knowledge base and for performing methods and algorithms according to example embodiments. All components need not be used in various embodiments.

One example computing device in the form of a computer 500 may include a processing unit 502, memory 503, removable storage 510, and non-removable storage 512. Although the example computing device is illustrated and described as computer 500, the computing device may be in different forms in different embodiments. For example, the computing device may instead be a smartphone, a tablet, smartwatch, smart storage device (SSD), or other computing device including the same or similar elements as illustrated and described with regard to FIG. 5. Devices, such as smartphones, tablets, and smartwatches, are generally collectively referred to as mobile devices or user equipment.

Although the various data storage elements are illustrated as part of the computer 500, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 503 may include volatile memory 514 and non-volatile memory 508. Computer 500 may include—or have access to a computing environment that includes—a variety of computer-readable media, such as volatile memory 514 and non-volatile memory 508, removable storage 510 and non-removable storage 512. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 500 may include or have access to a computing environment that includes input interface 506, output interface 504, and a communication interface 516. Output interface 504 may include a display device, such as a touchscreen, that also may serve as an input device. The input interface 506 may include one or more of a touchscreen, touchpad, mouse, keyboard, camera, one or more device-specific buttons, one or more sensors integrated within or coupled via wired or wireless data connections to the computer 500, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 500 are connected with a system bus 520.

Computer-readable instructions stored on a computer-readable medium are executable by the processing unit 502 of the computer 500, such as a program 518. The program 518 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 518 may be used to cause processing unit 502 to perform one or more methods or algorithms described herein.

Examples:
1. A computer implemented method includes receiving a search request from a user device, the search request including a verbal description of attributes of an icon corresponding to an app. The search request is processed via a natural language processing model to derive an intent of the search request to search for icon attributes. An icon knowledge base is searched in response to the derived intent. The icon knowledge base includes records with icon attributes generated by an image processor based on icons collected from an app storage, to identify a ranked list of apps. A search results is provided to the user device and identifies at least a top ranked app having an icon matching the verbal description of attributes.
2. The method of example 1 wherein searching is performed by the knowledge base to identify records of the icon knowledge base based on the verbal description of the search request.
3. The method of any of examples 1-2 wherein the image processor comprises a convolutional neural network image processor.
4. The method of any of examples 1-3 wherein the icon knowledge base includes records, each record containing an app name in addition to the icon attributes.
5. The method of example 4 wherein the record identifies that the app is installed on the user device.
6. The method of example 5 wherein the record includes a description of a function of the app.
7. The method of example 6 wherein the record includes a thumbnail of the icon for inclusion in the search result.
8. The method of example 6 wherein the record includes a link to an image of the icon.
9. The method of any of examples 1-8 wherein the search request is received from an app management application executing on the user device.
10. The method of example 1 wherein the knowledge base includes descriptions of the app generated by an LLM based on text collected from the app storage.
11. A machine-readable storage device having instructions for execution by a processor of a machine to cause the processor to perform operations to perform any of the methods of examples 1-10.
18. A device includes a processor and a memory device coupled to the processor and having a program stored thereon for execution by the processor to perform operations to perform any of the methods of examples 1-10.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
receiving a search request from a user device, the search request including a verbal description of attributes of an icon corresponding to an app;
processing the search request via a natural language processing model to derive an intent of the search request to search for icon attributes;
searching an icon knowledge base in response to the derived intent, the icon knowledge base including records with icon attributes generated by an image processor based on icons collected from an app storage, to identify a ranked list of apps, and
providing a search result to the user device, the result identifying at least a top ranked app having an icon matching the verbal description of attributes.

2. The method of claim 1 wherein searching is performed by the knowledge base to identify records of the icon knowledge base by matching terms of the verbal description of attributes of the icon against the icon attributes generated by the image processor in the records.

3. The method of claim 1 wherein the image processor comprises a convolutional neural network image processor.

4. The method of claim 1 wherein the icon knowledge base comprises records, each record containing an app name in addition to the icon attributes.

5. The method of claim 4 wherein the record identifies that the app is installed on the user device.

6. The method of claim 5 wherein the record includes a description of a function of the app.

7. The method of claim 6 wherein the record includes a thumbnail of the icon.

8. The method of claim 6 wherein the record includes a link to an image of the icon.

9. The method of claim 1 wherein the search request is received from an app management application executing on the user device.

10. The method of claim 1 wherein the knowledge base includes descriptions of the app generated by an LLM based on text collected from the app storage.

11. A non-transitory machine-readable storage device having instructions for execution by a processor of a machine to cause the processor to perform operations to perform a method, the operations comprising:
receiving a search request from a user device, the search request including a verbal description of attributes of an icon corresponding to an app;
processing the search request via a natural language processing model to derive an intent of the search request to search for icon attributes,
searching an icon knowledge base in response to the derived intent, the icon knowledge base including records with icon attributes generated by an image processor based on icons collected from an app storage, to identify a ranked list of apps; and
providing a search result to the user device, the result identifying at least a top ranked app having an icon matching the verbal description of attributes.

12. The device of claim 11 wherein searching is performed by the knowledge base to identify records of the icon knowledge base by matching terms of the verbal description of attributes of the icon against the icon attributes generated by the image processor in the records, wherein the icon knowledge base comprises records, each record containing an app name in addition to the icon attributes, identifies that the app is installed on the user device.

13. The device of claim 12 wherein the record includes a thumbnail of the icon.

14. The device of claim 12 wherein the record includes a link to an image of the icon.

15. The device of claim 11 wherein the image processor comprises a convolutional neural network image processor.

16. The device of claim 11 wherein the search request is received from an app management application executing on the user device.

17. The device of claim 11 wherein the knowledge base includes descriptions of the app generated by an LLM based on text collected from the app storage.

18. A device comprising:
a processor, and
a memory device coupled to the processor and having a program stored thereon for execution by the processor to perform operations comprising:
receiving a search request from a user device, the search request including a verbal description of attributes of an icon corresponding to an app,
processing the search request via a natural language processing model to derive an intent of the search request to search for icon attributes,
searching an icon knowledge base in response to the derived intent, the icon knowledge base including records with icon attributes generated by an image processor based on icons collected from an app storage, to identify a ranked list of apps; and
providing a search result to the user device, the result identifying at least a top ranked app having an icon matching the verbal description of attributes.

19. The device of claim 18 wherein searching is performed by the knowledge base to identify records of the icon knowledge base by matching terms of the verbal description of attributes of the icon against the icon attributes generated by the image processor in the records, wherein the icon knowledge base comprises records, each record containing an app name in addition to the icon attributes, identifies that the app is installed on the user device.

20. The device of claim 18 wherein the image processor comprises a convolutional neural network image processor.
